(19) United States
(12) Patent Application Publication
(10) Pub. No.: US 2026/0181263 A1
(43) Pub. Date: Jun. 25, 2026

(54) DEVICE TO CAPTURE HIGH RESOLUTION IMAGES OF A MOVING TRAIN USING LASER LIGHT FOR RAIL CAR INSPECTION AND METHOD TO USE

(71) Applicants: Derrick Schmenk, Jacksonville, FL (US); Jeffrey Necciai, Jacksonville, FL (US); Lorenzo Collante, Jacksonville, FL (US)

(72) Inventors: Derrick Schmenk, Jacksonville, FL (US); Jeffrey Necciai, Jacksonville, FL (US); Lorenzo Collante, Jacksonville, FL (US)

(21) Appl. No.: 19/545,297

(22) Filed: Feb. 20, 2026

Related U.S. Application Data
(63) Continuation-in-part of application No. 18/543,246, filed on Dec. 18, 2023.

(51) Int. Cl. H04N 23/74; B61L 25/02; B61L 27/57; H04N 23/72; H04N 23/73

(52) U.S. Cl. CPC H04N 23/74; B61L 25/021; B61L 27/57; H04N 23/72; H04N 23/73

(57) ABSTRACT

Laser lighting is used to capture high resolution images of a moving train as the train passes through a portal. On the respective sides, top and bottom of the portal a plurality of cameras are mounted to capture the images of the train. In certain applications a de-speckler is added to refine the light to its most functional use.

### CLAIM OF PRIORITY

The applicant is filing a continuation in part from a prior filed application filed on Dec. 18, 2023 with Ser. No. 18/543,246. The applicant is claiming priority based on this prior filed application.

### BACKGROUND OF THE INVENTION

In order to reduce costs and keep the railroad consumer informed, technology has been developed which will capture high-speed images of a moving train car. This technology will assist the end user's ability to detect possible maintenance repair, or safety issues and take corrective action.

This detection was previously performed with halogen or LED lighting to capture the images of a high-speed railroad car. Although railroad cars of trains will be discussed, this technology will also assist in the detection of defects in any high-speed moving objects such as trucks or aircrafts.

The technology will be applicable to all freight trains, as well as passenger trains. The illumination for rail car inspection portals is designed to capture high-speed images with a lower exposure to minimize motion blur in the photos that are captured.

As the cameras begin to increase resolution of the objective moving at a higher velocity, the need for more lighting is required. The disadvantage of using LED lighting is it would require more energy and increase cost to the product overall. Laser technology was developed to achieve the same or better quality image of the object (railroad car) using significantly less energy and fewer component parts.

### PRIOR ART

Laser technology currently exists in the prior art. Laser technology is useful for manufacturing purposes, point of sale systems and entertainment purposes. The incorporation of laser 9 technology using components to capture quality images of a moving object is not present in the prior art.

A representative example of the prior art includes Knowles, U.S. Pat. No. 7,658,330, which teaches the use of laser illumination in a point of sale (POS) system. The current application is not a point of sale system and POS systems are not used to capture images that travel at great speeds.

Another example can be found at Silver, U.S. Pat. No. 9,092,841, which teaches a method and apparatus for visual detection for inspection of objects. This patent does not teach the components that are used with this application and does not contemplate the use of this technology with rapidly moving objects such as trains.

Other examples that can be found in the prior art include Schofield, U.S. Pat. No. 9,843,777, Rogan, U.S. Pat. No. 11,532,221 and Zadeh, U.S. Pat. No. 8,103,085. None of the cited references discuss the use of laser illumination to capture quality images of a fast moving object using the components that are used with this application.

### BRIEF SUMMARY OF THE INVENTION

Trains move on a pair of designated tracks and trains themselves are a conglomeration of railroad cars. The type of car(s) that form the train are specific to the desired need of the user. A portal is a large structure that is open on both ends and the train passes through the portal as it moves along its path on the tracks. The portals are large, solid structures that expand over the track and are secured to the ground 8 adjacent to the track. The train passes through the interior of the portal.

On the sides of the portal will be a plurality of cameras, as well as lighting equipment. As the train cars pass through the portal images of the individual train cars are captured by the cameras. Before the cameras are triggered, the speed of the train is calculated using proprietary technology, and the speed of the train determines the shutter speed of the cameras. The plurality of cameras are positioned to capture images of all sides—top, bottom, sides, front, back—of each individual railroad car.

In order to capture a high-quality image of the railroad car as it passes through the portal, sufficient lighting is essential. In the past halogen or LED lighting was used to provide the source of illumination; both the halogen and LED lighting has drawbacks, which are addressed through laser lighting as a source of illumination.

An advantage of laser lighting is the distance (“throw distance) that the light can travel to illuminate a region of interest. Regardless of the type of lighting that is used, environmental considerations such as dim lighting, inclement weather, and reflections must always be considered.

Laser light is first put through a diffractive optic element to shape the output of light to match the requirements based on whether line scan or area scan cameras are being utilized. A line scan camera captures an image of a relatively small width whereas an area scan camera captures an image with a much broader width. The type of camera that will be used is dependent on the application that is involved.

Hardware for the system will include optical fiber cables, fiber couplers, laser light modules, collimators, and the cameras to capture the images.

The use of laser lights significantly reduces the amount of energy needed to achieve the same lighting power on target. With laser illumination, there is a much higher “throw” distance where the lighting power extends further, allowing the capture of more features in the target field of view. The simplicity of this design greatly reduces the number of active components in having mostly passive components.

As the train moves along the track, the speed of the train is calculated and the speed of the train will control the shutter speed of the cameras to capture the image. Target laser lighting is precise, focused lighting where relatively little to no loss of power density occurs as the light is aimed at the objective. This allows greater capability to capture images further away from the camera.

The captured images are stored in a server on site, and later restitched to form images of a complete train.

### BRIEF DESCRIPTION OF THE DRAWINGS

FIG. 1 is a schematic of the mono camera application.

FIG. 2 is a schematic of a color camera application using multiple laser modules.

FIG. 3 is a depiction of a mono camera application with de-speckler.

FIG. 4 is a schematic of a color camera application using multiple laser modules with a de-speckler.

FIG. 5 is a depiction of a module direct.

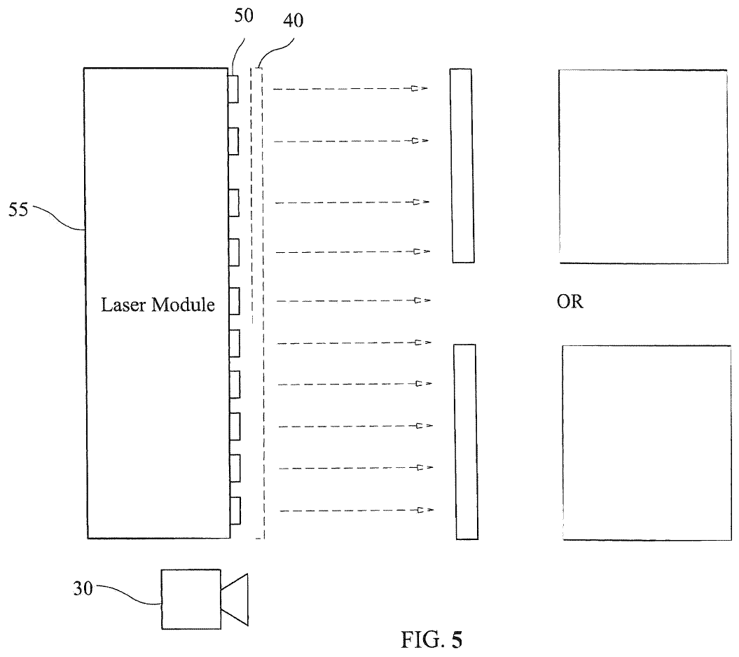

### NUMBERING REFERENCE

1 Device
5 Optical fiber cable
10 Fiber couplers
15 Collimator
15 Red laser module
20 Green laser module
25 Blue laser module
30 Camera
35 Diffractive optics
40 Optional polarization filter
45 De-speckler
50 Diffracted emitters
55 Laser Module

### DETAILED DESCRIPTION OF THE EMBODIMENTS

The use of lasers, which are devices that emit light, have many different applications from a range of extremely focused illumination for manufacturing purposes to entertainment. The current application uses laser technology as a source of illumination to capture high resolution images of a moving train. Although the capture of an image of moving train will be discussed in this application, this technology will have applications to capture different type of moving objects. An advantage of using laser light is the distance the light will travel to allow the image to be captured. This distance is referred to as the “throw distance”.

The application will have several embodiments that highlight the use of this technology. The embodiment that will be used will depend on several factors including but not limited to the desires of the end user, and the environmental conditions for a particular application.

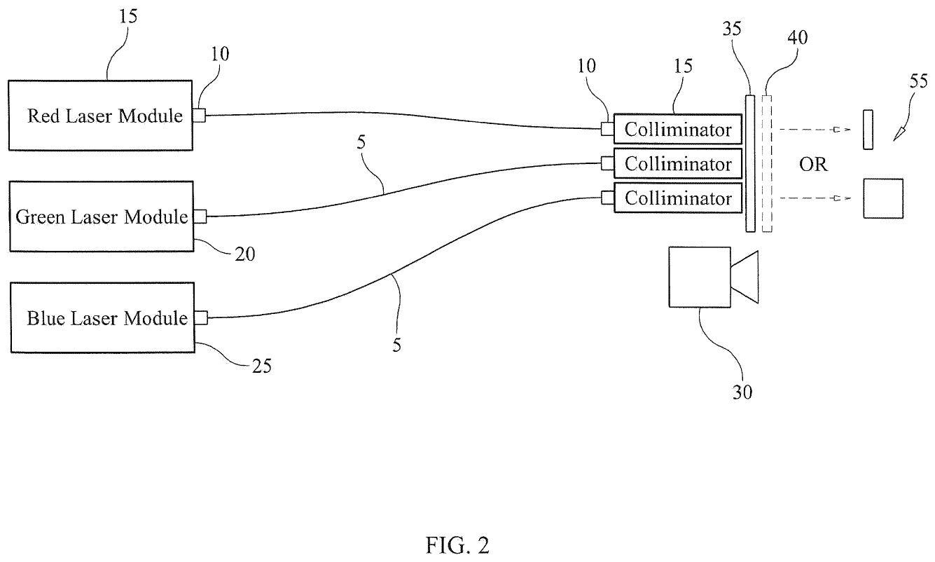

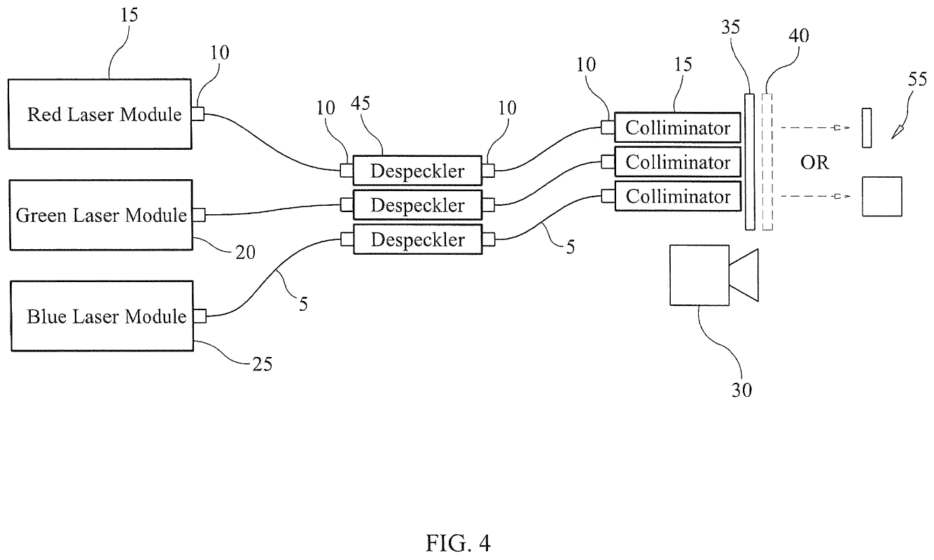

Regardless of the embodiment there are several components in this application. The first component is the laser module 15 that produces the laser light; optical fiber cables 5 and couplers 10 are used to connect the laser module to a collimator 15. The collimator receives the light from the laser and narrows the beam of light. More than one color of laser module may be used with this application such as depicted in FIGS. 2 and 4.

After the light is narrowed by the collimator, the light is passed through a diffractive optical element 35 to shape or bend 2 the light for the application.

A diffractive optical element is a specially manufactured piece of glass with etching; as the light from the laser travels through the etching a pattern will emerge. Many different types of diffractive optical elements exist but in this case the application is seeking to capture the height of a rail car; the light that passes through the diffractive optical element takes the shape of a narrow vertical beam of light from the ground surface to the top of the rail car. On the outside edges of the narrow vertical beam of light, shadows are formed. These shadows, when viewed with the naked eye, resemble the shape of a bat wing. When the intensity is mapped on a chart the peak intensity is at the edges of perspective and a parabolic curve of decreasing intensity in the middle; in the industry this light pattern is referred to as a bat wing view-bright light pattern in the middle with shadows on the sides of the beam of light.

In this case it is critical that the entire height of the train car is captured with even brightness in the images produced. Consequently, the beam of light that is produced as it passes through the diffractive optical element should be bright enough in the center with shadows on the sides of the light stream.

A polarization filter 40 may be included to reduce glare from the captured image; the polarization filter 40 may or May not be used depending on environmental conditions. Additionally, a de-speckler 45 may be used to remove speckles from the captured images to improve the quality of the captured image.

A plurality of cameras 30 are positioned on a portal (not depicted), which is a large structure that is mounted over the tracks through which a train will pass. The portal has defined sides and a defined top. Cameras 30 are placed on the sides of the portal and the top of the portal to capture images of all sides of the moving train as it passes through the portal. A particular application may use a line scan camera, which has a very narrow focus or an area scan camera that has a larger focus. The selection of a line scan camera or area scan camera will depend on the user and the environmental conditions.

Before the train passes through the portal, the speed of the train is calculated using technology that currently exists. The speed of the train is used to calibrate the shutter speed of the plurality of cameras 30.

FIG. 4 depicts a laser module 55 with diffracted emitters 50 and an optional polarization filter 40 to demonstrate the “throw distance” of the emitted light.

### First Embodiment

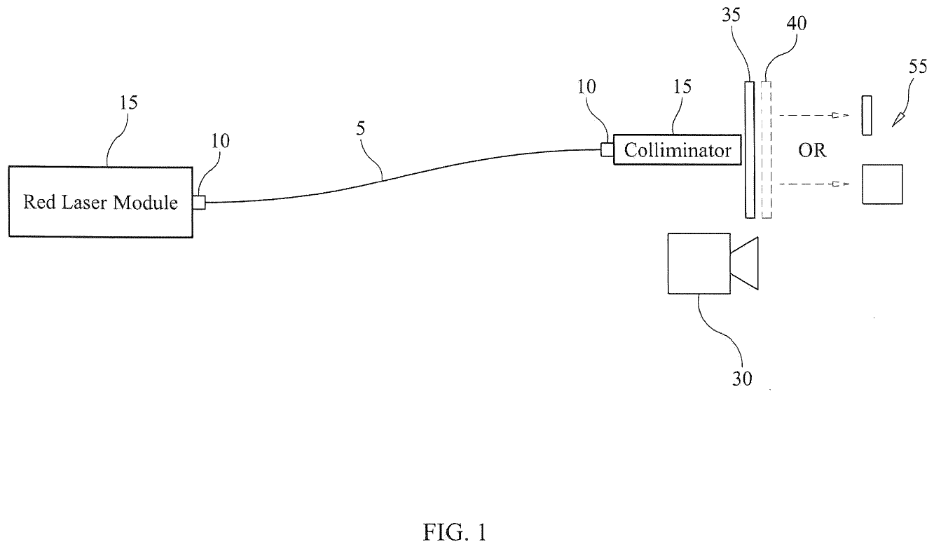

The single source camera application is an application which uses a camera and a single laser module 15, which passes the beam of light for the laser in a single wavelength to a collimator 15 via the optical fiber cable 5 such as depicted by FIG. 1. Fiber optic cables 5 and couplers 10 connect the laser module to the collimator in this application. The laser light passes from the collimator 15 through a diffractive optic element which shapes the projected laser light to the application, depending on if it is a line or area scan camera. The collimator and diffractive optic element are packaged into a water tight enclosure and mounted directly with the camera to allow for tight alignment tolerances. Optionally, this application can be fitted with a polarization filter that will allow for polarization of light and camera to reduce glare in the captured image.

### Second Embodiment

For color camera applications, three wavelength laser modules covering red, green, and blue visual spectrums are used such as depicted in FIG. 2. There are three separate lasers to supply the correct wavelengths needed to get color images from the cameras. The modules 15, 20, and 25 are connected to individual collimators 15 or spliced into a single fiber and collimator 15. The light from each of the collimators 15 pass through a diffractive optical element 35 including a polarization filter 40, if needed.

### Third Embodiment

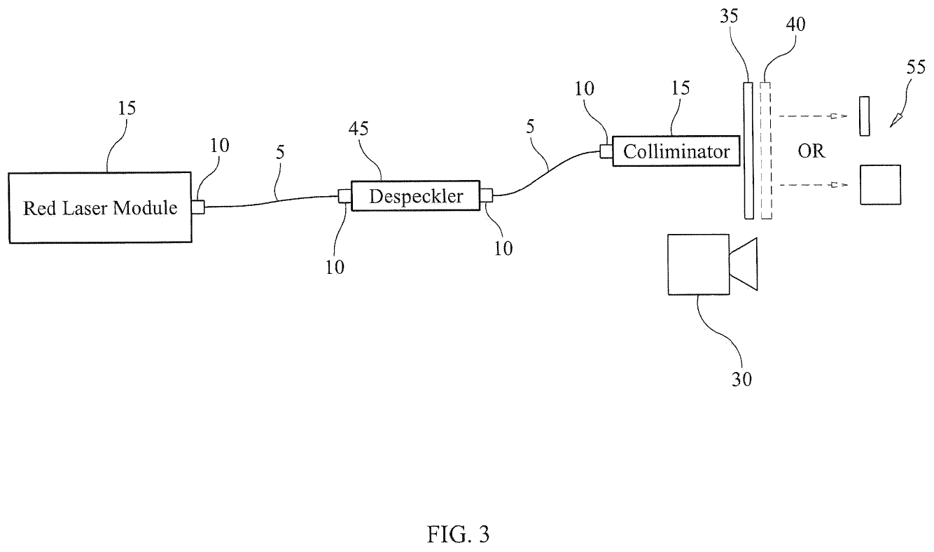

In some instances, a de-speckler 45 may be used in conjunction with the single camera application such as depicted in FIG. 3 or in a multiple laser module application such as depicted in FIG. 4. In this embodiment, the laser module passes the laser light to the de-speckler via an optical fiber cable. The laser light passes again via a fiber optic cable to the collimator and finally, the laser then passes through a diffractive optic element which shapes the projected laser light to the application. The de-speckler 45 is used for applications where further laser divergence is needed and helps reduce the speckling in imaging that can occur when direct, reflected, converged laser light hits the camera sensor.

### Fourth Embodiment

In a fourth embodiment, the laser module contains laser diodes, collimators and diffractive optic elements. This unit is mounted directly with the camera and will project light in alignment with a specific camera application.

While the embodiments of the invention have been disclosed, certain modifications may be made by those skilled in the art to modify the invention without departing from the spirit of the invention.

The inventor claims:

1. A device to capture high resolution images of a moving train using laser light for rail car inspection and method to use, which is comprised of:
a laser module,
wherein the laser module produces a stream of light,
wherein the stream of light is a combined light source,
wherein the laser module separates the combined light source into specific colors,
wherein the combined light source is a constant stream of light,
fiber optic cable,
wherein the laser module is connected to fiber optic cable couplers,
collimator,
wherein the collimator narrows the beam of light that is produced by the laser module,
diffractive optical element,
wherein the diffractive optical element bends the light as it exits the collimator,
wherein the diffractive optical element produces a narrow beam of light,
wherein said narrow beam of light extends vertically from the ground surface to a top surface of a rail car,
a plurality of cameras,
wherein the plurality of cameras capture the images of the moving train.

2. A device to capture high resolution images of a moving train using laser light for rail car inspection and method to use as described in claim 1 wherein the plurality of cameras are line scan cameras.

3. A device to capture high resolution images of a moving train using laser light for rail car inspection and method to use as described in claim 1 wherein the plurality of cameras are area scan cameras.

4. A device to capture high resolution images of a moving train using laser light for rail car inspection and method to use which is comprised of the following steps:
determining the speed of a train,
calibrating the shutter speed of a plurality of cameras based on the speed of the train,
emitting the light from a single laser module,
passing the light through a collimator,
passing the light through a diffractive optical element,
capturing the images of the moving train as it passes through a portal.

5. A device to capture high resolution images of a moving train using laser light for rail car inspection and method to use as described in claim 4 wherein a polarization filter is added.

6. A device to capture high resolution images of a moving train using laser light for rail car inspection and method to use which is comprised of the following steps:
determining the speed of a train,
calibrating the shutter speed of a plurality of cameras based on the speed of the train,
emitting the light from multiple laser modules,
passing the light stream from the individual laser modules through a collimator,
passing the light from each of the collimators through a diffractive optical element,
capturing the image of the moving train as it passes through a portal.

7. A device to capture high resolution images of a moving train using laser light for rail car inspection and method to use as described in claim 6 wherein a polarization filter is used.

8. A device to capture high resolution images of a moving train using laser light for rail car inspection and method to use, which is comprised of:
a laser module,
wherein the laser module produces a stream of light,
wherein the stream of light is a combined light source,
wherein the laser module separates the combined light source into specific colors,
wherein the combined light source is a constant stream of light,
fiber optic cable,
wherein the laser module is connected to fiber optic cable couplers,
collimator,
wherein the collimator narrows the beam of light that is produced by the laser module,
diffractive optical element,
wherein the diffractive optical element bends the light as it exits the collimator,
a plurality of cameras,
wherein different colors of light in the stream of light are used,
wherein the plurality of cameras capture the images of the moving train.

9. A device to capture high resolution images of a moving train using laser light for rail car inspection and method to use as described in claim 8, wherein the color in the stream of light is red.

10. A device to capture high resolution images of a moving train using laser light for rail car inspection and method to use as described in claim 8, wherein the color in the stream of light is blue.

11. A device to capture high resolution images of a moving train using laser light for rail car inspection and method to use as described in claim 8, wherein the color in the stream of light is green.
